(19) United States
(12) Patent Application Publication
(10) Pub. No.: US 2006/0085536 A1
(43) Pub. Date: Apr. 20, 2006

(54) System and method for sharing data polling and buffering for multiple requesters

(75) Inventors: Joel Peter Meyer, Durham, NC (US); William Augustus Parvin, Fuquay Varina, NC (US); Wenjian Qiao, Cary, NC (US); Dean Merritt West II, Cary, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/954,457

(22) Filed: Sep. 30, 2004

(51) Int. Cl. G06F 15/173

(52) U.S. Cl. 709/224

(57) ABSTRACT

A system and method for sharing data polling and buffering for multiple requesters are provided. With the present invention, a user/computing device may register with a data polling system whose purpose is to periodically poll computer system resources for data. This data is stored in a common storage buffer with pointers to the data being stored in index data structures for a plurality of users. More than one user index data structure may have a pointer to the same data location in the common storage buffer. In addition, a mechanism for aligning data pollings among a plurality of users/computing devices is provided so as to increase the amount of sharing of data stored in the common storage buffer.

### BACKGROUND OF THE INVENTION

1. Technical Field

The present invention is generally directed to an improved data processing system. More specifically, the present invention is directed to a system and method for sharing polled data amongst a plurality of requesters, such as computer system performance data being monitored by multiple requesting data processing systems.

2. Description of Related Art

Performance monitoring tools are implemented to monitor the performance of various aspects of computer systems. These performance monitoring tools may monitor the performance of particular applications running on computer systems, the performance of particular resources of a computer system, or the like. Moreover, such performance monitoring tools may be used to monitor the performance of applications/resources of a plurality of computer systems, such as computer systems that are part of a local area network (LAN), wide area network (WAN), a virtual private network (VPN), the Internet, or the like. There are many different uses and implementations of performance monitoring tools in currently existing computing environments.

One example of a performance monitoring tool that is available through the Microsoft Windows™ operating system is the Windows Task Manager Performance tool. By selecting “Task Manager” and then selecting the “Performance” tab that appears in the “Task Manager” window, a graphical representation of CPU usage and memory usage over a period of time may be obtained. This graphical representation is updated periodically with new performance data obtained from the CPU and memory usage monitoring agents.

When a user monitors performance data via a performance monitoring tool, the user usually views the performance data in the form of a table, chart, or other organization of data. The user will set a refresh interval so that the table or chart will be updated with a new data point periodically based on the designated refresh rate. For example, in the Windows Task Manager Performance tool described above, a drop-down menu is provided for a user to select a refresh speed, e.g., high, normal, low, or paused.

Based on the designated refresh interval, the performance monitoring tool must obtain a new data point and display it in the table, chart, graph, etc. In addition, the performance monitoring tool must buffer a number of data points so that the user can view a short performance history in the table, chart, graph, etc.

If multiple users are using the performance monitoring tool at the same time, such as in a network computing environment in which the performance of the network resources are being monitored by the performance monitoring tool, each user may set a different refresh rate. Since the performance monitoring tool must retrieve the performance data from the monitored resources for each individual user, significant overhead may occur due to multiple remote data accesses. In addition, storing historical data points for each user may require large amounts of memory depending on the number of users and the number of data points maintained in the history buffer.

Thus, it would be beneficial to have an improved system and method for sharing polled data, such as performance data obtained from resources via a performance monitoring tool, amongst a plurality of users.

### BRIEF SUMMARY OF THE INVENTION

The present invention is directed to a system and method for sharing data polling and buffering for multiple requesters, i.e. users or computing devices. With the present invention, a user/computing device may register with a data polling system, such as a performance monitoring tool, whose purpose is to periodically poll computer system resources for data and then provide that data to the user/computing device at a designated time interval. The terms “poll” and “polling” as they are used in this description refer to periodic requests or interrogations of computer system resources for data. In one exemplary embodiment of the present invention, the polling is used to obtain performance data related to the operation of a resource within the computing system or computing system environment.

When the user/computing device registers with the data polling system, the user/computing device may provide a start time and a refresh value. The start time indicates the time at which a first polling of data is performed with the refresh value identifying the time interval between subsequent pollings of data. The start time may be any time at which the user wishes to start polling of data from computer system resources, and, in a preferred embodiment, may be the time at which the user/computing device completes registration with the data polling system. The refresh value is preferably a multiple of a predetermined minimum unit of refresh interval, i.e. minimum refresh value, set by the data polling system.

Upon registering with the data polling system, a user/computing device data structure is created that identifies the start time and refresh value associated with the user/computing device. In addition, a counter and a data index table may be associated with the user/computing device data structure. In a preferred embodiment, the counter is originally set at a value equal to the refresh value associated with the user/computing device. However, this counter value may be modified as needed in order to line up users/computing devices so that polled data may be shared among users/computing devices, as discussed hereafter.

Each time the process of the present invention checks to see if a new polling of data from computer system resources is necessary, the counters of the registered users/computing devices are modified by an amount equal to the predetermined minimum refresh value. In a preferred embodiment, if a counter reaches a value of zero, data is polled from the system resources for the particular user/computing device associated with the counter that reached a value of zero.

In operation, a process is awaken periodically, i.e. at a wake-up time, based on the predetermined minimum unit of refresh interval, or minimum refresh value, set by the data polling system. When the process awakens, counters for the various users/computing devices are updated and a determination is made as to whether any of the users/computing devices require a polling of data from the computer system resources. If at least one user/computing device requires a polling of data from the computer system resources, the process initiates the polling, gathers the data from the computer system resources and stores this data.

The data is stored in a common data storage that is common to all of the registered users/computing devices. That is, there is one data storage for all of the users/computing devices and each user/computing device obtains access to the polled data that is in this common data storage. The particular data accessed by each user/computing device is governed by the user's/computing device's data index table.

When data is polled from the computer system resources and stored in the common data storage, the users/computing devices whose counter value has reached zero have their corresponding data index tables updated to include a pointer to the new data stored in the common data storage. Users/computing devices whose counters are not zero do not include a pointer to this new data in the common data storage. In this way, the users/computing devices share the data in the common data storage but each user/computing device has its own set of data based on the start time and refresh value set by the user/computing device.

In order to reduce the amount of space necessary to store the data polled from the computer system resources, a further aspect of the present invention involves “lining-up” the users/computing devices so that they may share a larger majority of the data in the common data storage. With the present invention, after an initial data polling of the computer system resources at the start time for the user/computing device, subsequent pollings of the computer system resources are aligned with at least one other user's/computing device's periodic pollings of the computer system resources so that more users/computing devices share the same data in the common data storage and a lower number of pollings of the computer system resources are necessary. In essence, for subsequent pollings of the computer system resources, the present invention shifts the start time such that it appears as if the start time were such that the subsequent pollings are in line with the other user's/computing device's pollings.

These and other features and advantages of the present invention will be described in, or will become apparent to those of ordinary skill in the art in view of, the following detailed description of the preferred embodiments.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing environment in which aspects of the present invention may be implemented;

FIG. 2 is an exemplary diagram of a server computing system in which aspects of the present invention may be implemented;

FIG. 3 is an exemplary diagram of a client or stand alone computing system in which aspects of the present invention may be implemented;

FIG. 4 is an exemplary diagram illustrating the primary operation elements of one exemplary embodiment of the present invention;

FIG. 5 is an exemplary diagram illustrating a polling system user data structure in accordance with one exemplary embodiment of the present invention;

FIG. 6 is an exemplary diagram illustrating one example of the manner by which data index tables for a plurality of users may be used to share data in a common data storage in accordance with one exemplary embodiment of the present invention; and

FIG. 7 is a flowchart outlining an operation for polling data from computer system resources and making it available to registered users in accordance with one exemplary embodiment of the present invention.

### DETAILED DESCRIPTION OF THE INVENTION

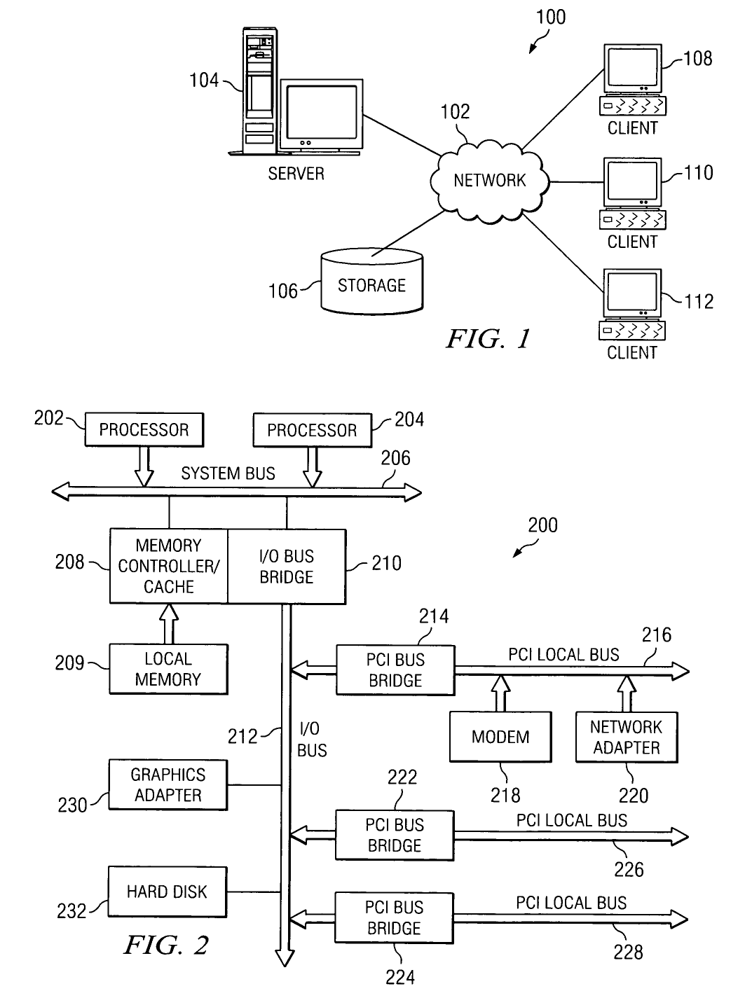

The present invention is directed to a system and method for sharing data polling and buffering for multiple users. The present invention may be implemented in a stand alone computing system or in a distributed data processing environment having a plurality of computer system resources interconnected by one or more data networks. As such, FIGS. 1-3 are provided as exemplary computing environments in which aspects of the present invention may be implemented. FIGS. 1-3 are only provided as examples and many modifications to the computing environments and devices illustrated in FIGS. 1-3 may be made without departing from the spirit and scope of the present invention. FIGS. 1-3 are not intended to state or imply any limitation as to the particular types of computing devices or the particular computing environments in which aspects of the present invention may be implemented.

With reference now to the figures, FIG. 1 depicts a pictorial representation of a network of data processing systems, i.e. a distributed data processing environment, in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

In the exemplary distributed data processing environment illustrated in FIG. 1, server 104 may provide a data polling system that may be used by users of client devices 108-110 to obtain periodically polled data from computer system resources, such as storage device 106 and/or other computer system resources not explicitly shown in FIG. 1. For example, the data polling system may be a performance monitoring tool provided by server 104 for monitoring the performance of various computer system resources, such as CPU usage, memory usage, network bandwidth usage, storage capacity usage, etc.

The users of the client devices 108-112 may register with the data polling system of server 104 and provide refresh values to the server 104 to inform the server 104 of how often the users of the client devices 108-112 wish to receive new data points. The present invention may be implemented, for example, in a data polling system of server 104 so as to permit sharing of a common polled data storage structure and reduce the size of this common polled data storage structure when compared to conventional systems.

Referring now to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

The exemplary server computing device illustrated in FIG. 2 may be used to provide a data polling system for periodically polling computer system resources for data, e.g., performance data, operational condition data, etc. The data polling system may be implemented in the server 200 as one or more software applications running on the server 200, as a separate hardware device integrated into the server 200, or as a separate computing device coupled to the server 200. The server 200 may communicate with client devices 108-112 to receive user registrations for data polling and provide polled data to the users when requested.

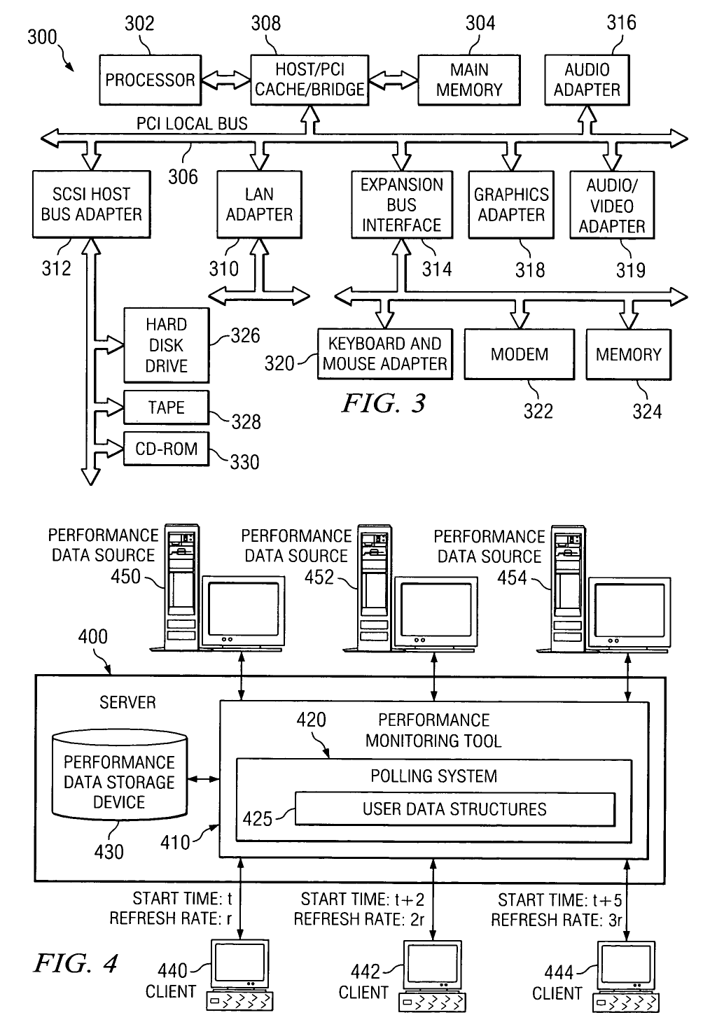

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The exemplary client computing device 300 illustrated in FIG. 3 may be used to register a user as a recipient of polled data from computer system resources. The client computing device 300 may also be used to present polled data to a user of the client computing device 300 for their review.

As mentioned above, the present invention provides a mechanism by which multiple requesters, e.g., users, client computing devices, or the like, may share polled data from computer system resources and the number of pollings performed with regard to the computer system resources may be reduced when compared to current mechanisms for performing such operations. The present invention may be utilized, for example, to monitor the state of a distributed data processing system both as a whole and with regard to individual computing system resources within the data processing system. The present invention may be implemented in conjunction with existing or later developed performance monitoring tools or any other type of computing system that periodically requests data from computer system resources and compiles this data for use.

With the present invention, a user may make use of their client computing device to register with a data polling system, such as a performance monitoring tool, whose purpose is to periodically poll computer system resources for data and then provide that data to the user at a designated time interval. In one exemplary embodiment of the present invention, the polling is used to obtain performance data, i.e. resource usage and state information, related to the operation of a resource within the computing system or computing system environment.

When the user registers with the data polling system, the user may provide a start time and a refresh value. Alternatively, the start time may be automatically determined based on a time at which the user completes registration with the data polling system, or the like. A graphical user interface may be provided for the user of the client device to enter necessary information in order to register with the data polling system. Alternatively, rather than requiring a human user to manually register with the data polling system, the present invention may be implemented with an automated system in which a client computing device, or other type of computing device, automatically requests polling of data from computer system resources.

The start time indicates the time at which a first polling of data is performed with the refresh value identifying the time interval between subsequent pollings of data. The start time may be any time at which the user wishes to start polling of data from computer system resources, and, in a preferred embodiment, may be the time at which the user completes registration with the data polling system. The refresh value is preferably a multiple of a predetermined minimum unit of refresh interval set by the data polling system. For example, if the minimum unit of refresh interval is set to be 5 seconds, the refresh values for users may be 5, 10, 15, 20, etc. seconds.

Upon registering with the data polling system, a user data structure is created that identifies contact information for the user, e.g., client device network address, the start time, and the refresh value associated with the client device. In addition, a counter and a data index table may be associated with the user data structure. The counter is provided in this exemplary embodiment as a mechanism by which to determine when the particular user requires a new polled data to be provided. Other mechanisms may be used without departing from the spirit and scope of the present invention. For example, timestamp information may be stored identifying the last time that data was polled from computer system resources and this timestamp information may be used along with current clock information to determine whether a new set of polled data is required for a particular user.

In a preferred embodiment, the counter is originally set at a value equal to the refresh value associated with the user. Thus, for example, if the refresh value is 20 seconds, then the counter is originally set at a value of 20 seconds. In such a case, the counter is decremented, as discussed hereafter, until it reaches zero at which time a new polling of data from computer system resources is performed for this user/client device and the counter is then reset. Alternatively, the counter may be set at an initial value, such as zero, and the counter value may be increased until it reaches the same value as the refresh value at which time a new polling of data from the computer system resources is performed.

Each time the process of the present invention checks to see if any registered user/client device requires a new polling of data from the computer system resources, the counters of the registered users/client devices are modified by an amount equal to the predetermined minimum refresh value. For example, if the counter value for a user/client device is currently set at 20 seconds and the minimum refresh value is 5 seconds, then the counter is decremented by 5 seconds so that the counter is now set at 15 seconds. If a counter reaches a value of zero, data is polled from the system resources for the particular user/client device associated with the counter that reached a value of zero. The counter may then be reset to its original value, e.g., 20 seconds in the example discussed above.

In operation, a process of the present invention is awaken periodically, i.e. at a wake-up time, based on the predetermined minimum unit of refresh interval, i.e. the minimum refresh value, set by the data polling system. Thus, for example, if the minimum unit of refresh interval is 5 seconds, the process is awaken every 5 seconds to evaluate whether a new polling of data from computer system resources is necessary.

When the process awakens, counters for the various registered users/client devices are updated and a determination is made as to whether any of the users/client devices require a polling of data from the computer system resources, e.g., a determination is made as to whether any of the counters are equal to zero. If at least one user/client device requires a polling of data from the computer system resources, the process initiates the polling, gathers the data from the computer system resources and stores this data. If none of the registered users/client devices require a polling of data from the computer system resources, the process simply goes back to sleep until the next wake-up time.

The data is stored in a common data storage that is common to all of the registered users/client devices. That is, there is one data storage for all of the users/client devices and each user/client device obtains access to the polled data that is in this common data storage. The particular data accessed by each user/client device is governed by the user/client device's data index table.

When data is polled from the computer system resources and stored in the common data storage, the users/client devices whose counter value has reached zero have their corresponding data index tables updated to include a pointer to the new data stored in the common data storage. Users/client devices whose counters are not zero do not include a pointer to this new data in the common data storage. In this way, the users/client devices share the data in the common data storage but each user/client device has its own set of data based on the start time and refresh value set by the user/client device.

In order to reduce the amount of space necessary to store the data polled from the computer system resources, a further aspect of the present invention involves “lining-up” the users/client devices so that they may share a larger majority of the data in the common data storage. With the present invention, after an initial data polling of the computer system resources at the start time for the user/client device, subsequent pollings of the computer system resources are aligned with at least one other user's/client device's periodic pollings of the computer system resources so that more users/client devices share the same data in the common data storage and a lower number of pollings of the computer system resources are necessary. In essence, for subsequent pollings of the computer system resources, the present invention shifts the start time such that it appears as if the start time were such that the subsequent pollings are in line with the other user's/client device's pollings.

In one exemplary embodiment of the present invention, this shifting of the pollings is performed by modifying the current value of the counter associated with a user's data structure so that the counter value is set to a value that causes the counter to reach zero at the same time as the counter of another user/client device. In one exemplary embodiment, this modification is performed by calculating a value for the counter as a function of the refresh value associated with the user/client device.

The particular function of the refresh value is based on a function of the wake up time and the start time of the other user's/client device's polling of data from the computer system resources, i.e. the user/client device with which the present user's/client device's data polling times are being aligned. Once aligned, for subsequent data pollings, both users'/client devices' data index tables will include pointers to the same data in the common data storage thereby reducing the amount of data stored in the common data storage and reducing the required size of the common data storage.

Thus, the present invention provides a mechanism for polling computer system resources for data, combining data obtained from polling computer system resources into a single common data structure, and a mechanism for reducing the size of this common data structure by lining up pollings for a plurality of users/client devices. In this way, the number of pollings necessary to obtain data for each user is reduced and the size of the memory or other storage necessary to store this polled data is reduced.

FIG. 4 is an exemplary diagram illustrating the primary operation elements of one exemplary embodiment of the present invention. The exemplary embodiment illustrated in FIG. 4 is described in terms of a performance monitoring tool being provided on a server computing device. As mentioned above, the present invention is not limited to such an embodiment and may be used with any system that periodically obtains data from computer system resources for a plurality of requesters, i.e. users/computing devices.

In addition, the example shown in FIG. 4 and examples shown in subsequent figures will be described in terms of performing data pollings for a plurality of “users” for simplicity. In this context, a “user” may be an actual person making use of a client device or may be the client device itself. As mentioned above, rather than having a user manually request polling of data from computing system resources, the present invention may be implemented with an automated system in which a client computing device, or other type of computing device, automatically requests polling of data from computer system resources.

As shown in FIG. 4, a server 400 includes a performance monitoring tool 410 which is used to monitor the performance of the computing system resources on performance data sources 450, 452 and 454. Moreover, the performance monitoring tool 410 may be used to monitor the performance of one or more networks interconnecting performance data sources 450, 452 and 454 with server 400 and/or client computing devices 440, 442 and 444. The performance monitoring tool 410 includes a polling system 420 in accordance with the present invention. The polling system 420 stores user data structures 425 for registered users of the performance monitoring tool 410. These user data structures 425 are used to determine which users require new pollings of data from the performance data sources 450-454 and are used to access data stored in the performance data storage device 430.

The performance data storage device 430 stores data obtained from polling the performance data sources 450-454. The performance data storage device 430 may be any type of storage device including a hard drive, a memory, an optical drive, etc. In a preferred embodiment, the performance data storage device 430 is a data buffer stored in memory.

As shown in FIG. 4, users of the client devices 440-444 register with the polling system 420 of the performance monitoring tool 410 to receive performance data at periodic times identified by the refresh rate stipulated by the user. As shown, each user may initiate polling of data from the performance data sources 450-454 at different start times and may have different refresh rates for this polled data. For example, the user of client 440 starts performance monitoring at a start time t and has a refresh rate r, where r is the minimum refresh rate set by the polling system 420. The user of client 442 starts performance monitoring at start time t+2 and has a refresh rate of 2r. Similarly, the user of client 444 starts performance monitoring at start time t+5 and has a refresh rate of 3r. These different start times and refresh rates are stored in user data structures 425 for each user along with a data index table and a counter for each user.

In a preferred embodiment, the counter for each user is initially set to a value equal to that of the refresh rate stipulated by the user. Thus, the initial counter values for users of client devices 440-444 are r, 2r and 3r, respectively. A process of the polling system 420 is awakened based on the minimum refresh rate. That is, if the minimum refresh rate is r seconds, the process is awaken every r seconds. This process decrements the counter values for all of the user data structures 425 by a value equal to the minimum refresh rate and then checks to see if any of the counter values has reached zero. Any user data structures 425 that have a counter value that is equal to zero are identified as requiring a new polling of data from the performance data sources 450-454. As mentioned above, other mechanisms may be used to determine when to poll data from the performance data sources 450-454, such as using timestamps, without departing from the spirit and scope of the present invention.

Thus, for example, when the process of the polling system 420 awakens, the counters for the users of client devices 440-444 are decremented by the refresh rate r. As a result, the counter value for the user of client computing device 440 is 0, the counter value for the user of client computing device 442 is r, and the counter value for the user of client computing device 444 is 2r. Thus, only the user of client computing device 440 requires an updated polling of data from performance data sources 450-454.

The performance data sources 450-454 are polled for new performance data which is received by the performance monitoring tool 410, such as by using performance monitoring agents on the performance data sources 450-454 for example, and stored in the performance data storage device 430. A pointer to this newly stored data in the data location in performance data storage device 430 is stored in the data index tables of the user data structures that have a counter whose value is zero. Thereafter, the counters for these user data structures are reinitialized to be equal to the refresh rate stored in the user data structure. The process is then placed back in a sleep state until the next wake-up time, e.g., r seconds from the last wake-up time, when the above operations are repeated.

In addition to storing the data in the performance data storage device 430, this data may be sent to the client computing devices 440-444 for processing. This processing may involve graphically rendering the data, generating one or more reports based on the data, or the like. In a preferred embodiment, the data corresponding to the pointers stored in the user data structure associated with the client device 440-444 is used to provide a graphical representation of the performance data for the window of time represented by the set of pointers.

This window of time may be dynamically shifted as new performance data is obtained and stored in the performance data storage device 430. That is, the data index table and the performance data storage device 430 may wrap such that a dynamically moving window of time of performance data is represented by these structures.

It can be seen that if each user of each client device 440-444 starts performance monitoring at a different start time and has either the same or a different refresh rate, many times the points in time where the performance data sources 450-454 are polled to obtain performance data will not coincide. This results in many interrogations of the performance data sources 450-454 as well as a larger amount of performance data having to be stored in the performance data storage device 430. As a result, the performance monitoring performed by the performance monitoring tool 410 may be intrusive to the operation of the performance data sources 450-454 and may require large amounts of memory or storage space to store the performance data.

With a further aspect of the present invention, the number of interrogations of the performance data sources 450-454 is significantly reduced. In addition, the size of the storage footprint of the performance data in the performance data storage device 430 is also significantly reduced.

This further aspect of the present invention aligns data pollings for users such that more than one user requires a polling of the performance data sources 450-454 at the same time. As a result, a single polling of data from the performance data sources 450-454 satisfies the request for performance data from a plurality of users. This significantly reduces the number of pollings or interrogations that are necessary.

Moreover, since there are less pollings or interrogations of the performance data sources 450-454, there is less performance data that needs to be maintained in the performance data storage device 430. As a result, more than one user makes use of the same performance data stored in the performance data storage device 430 and the storage footprint for the performance data is reduced in size. The mechanisms of exemplary embodiments of the present invention for aligning data pollings for a plurality of users will be described in greater detail hereafter with reference to FIG. 6.

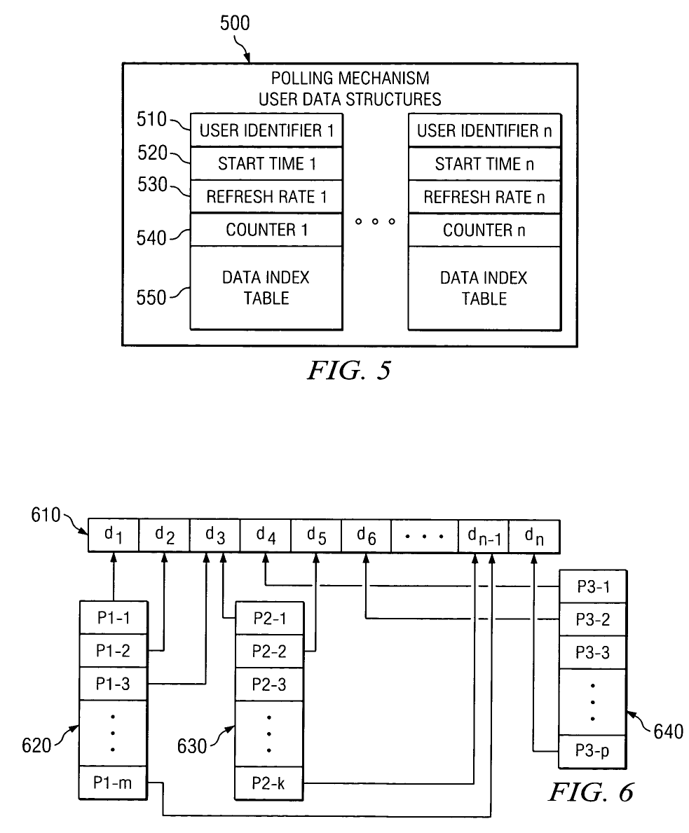

FIG. 5 is an exemplary diagram illustrating a polling system user data structure in accordance with one exemplary embodiment of the present invention. As shown in FIG. 5, the polling system user data structures 500 include, for each registered user, a user identifier 510, a start time 520, a refresh rate 530, a counter 540, and a data index table 550. The user, or computing device, may define the start time 520, the refresh rate 530 and the size of the data index table 550. The counter 540, in a preferred embodiment, is initially set to a value equal to the refresh rate 530 but is modified by either being decremented by a process of the polling system or modified to a different value to align the user with other users, as discussed hereafter. The start time may be specified by the user or computing device or may be set automatically by the system as the time at which registration of the user/computing device is completed and polling of data is initiated.

As stated above, the size of the data index table 550 may be specified by a user or by a computing device. The size of the data index table 550 dictates the size of the time window of polled data that may be represented to a user or computing device. That is, when the data index table 550 becomes full, the data index table 550 wraps to the first entry in the data index table 550 and overwrites existing entries. The data storage device referenced by pointers in the data index table 550 may also wrap in this fashion, however this is optional and the data storage device may not wrap in order to provide a complete history of polled data.

The pointers that are stored in the data index table 550 are used to access corresponding data in a data storage device. When a user or computing device requests data from the data storage device, the pointers in the data index table 550 for that user/computing device are used to retrieve the data and provide it to the user/computing device for processing.

FIG. 6 is an exemplary diagram illustrating one example of the manner by which data index tables for a plurality of users may be used to share data in a common data storage in accordance with one exemplary embodiment of the present invention. As shown in FIG. 6, there are a plurality of data index tables 620-640 corresponding to a plurality of different users/computing devices that have registered to receive polled data. These data index tables 620-640 include pointers to data stored in the data storage device 610. In a preferred embodiment, the data storage device 610 is a buffer of polled data, e.g., performance data obtained from performance data sources, stored in memory.

As shown in FIG. 6, each pointer, e.g., P1-1, P2-1, P3-1, etc., points to a particular data location in data storage device 610. In addition, each data index table 620-640 has a different size as dictated by the user or computing device associated with the data index table. For example, the data index table 620, associated with a first user, has a size m while data index tables 630 and 640 have sizes k and p, respectively.

Since users may not start polling data at the same time, and may designated different refresh rates, it is possible that none of the data entries, or at least very few data entries, in the data storage device 610 may be shared among the users. Thus, there is a need for a mechanism to enforce greater sharing of polled data amongst users. The present invention provides such a mechanism by shifting the time at which polling of data is performed so that more than one user makes use of the same polling of data from the computer system resources.

To illustrate this mechanism, assume that there are two users, both of which have a refresh rate of 20 seconds but user A starts polling data at time 100 while user B starts polling data at time 105. The time series for retrieving data for these two users would be as follows:

User A: 100, 120, 140, . . .

User B: 105, 125, 145, . . .

It is clear from these time series that the two users can never share the polled data because they always poll the computer system resources at different times. However, if the two users are aligned or lined up, these two users may be able to share a majority of the polled data and may poll the computer system resources at the same time allowing a single polling of the computer system resources to satisfy both user's requirements. That is, it would be beneficial to align user B so that his time series of data pollings is as follows:

User B: 105, 120, 140 . . .

In order to provide such alignment, the present invention, in one exemplary embodiment, modifies the counter value for user B, following user B's initial data polling, to be a function of user B's refresh rate and a counter value of user A if the counter value for user B is greater than zero. If the counter for user B is equal to zero, then the counter value for user B is set to be equal to the refresh rate of user B. One exemplary embodiment of this function may be provided as follows:
C_{B}=C_{A} mod R_{B}
if (C_{B}==0)C_{B}=R_{B}
where C_{B} is the counter value for user B, R_{B} is the refresh rate for user B, and C_{A} is the counter value for user A. This insures that user B and user A will share the next polling in which they both are due.

In the case where refresh rates are different it may not be possible to share all the polling intervals. The present invention schedules the pollings for all the users in such a way that whenever possible they poll at the same time. If two users share a single polling, thereafter they will share any pollings that they have in common.

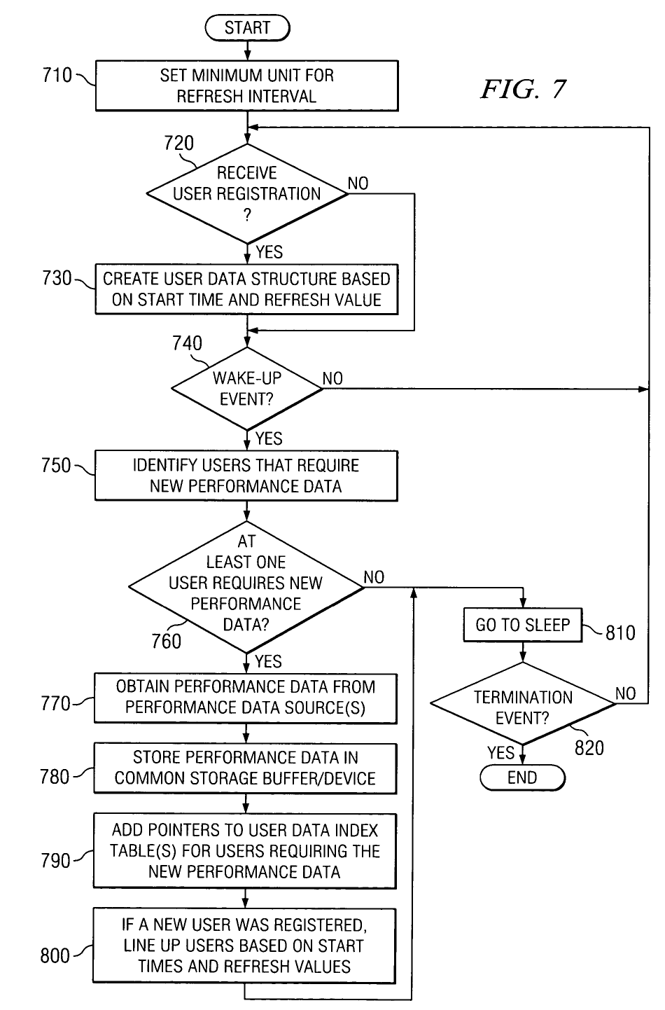

FIG. 7 is a flowchart outlining an operation for polling data from computer system resources and making it available to registered users in accordance with one exemplary embodiment of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 7, the operation starts by setting a minimum unit of refresh interval (step 710). Thereafter, a determination is made as to whether a new user has registered to receive polled data (step 720). If so, a user data structure is create based on the start time and refresh value specified by the user (step 730). Thereafter, or if a new user has not registered to receive polled data, a determination is made as to whether a wake-up event has occurred (step 740).

If a wake-up event has not occurred (step 740), the operation returns to step 720 and continues to monitor for new users and a wake-up event. If a wake-up event has occurred, the users that require new performance data are identified (step 750). As discussed above, in a preferred embodiment, this may involve decrementing counters associated with user data structures and identifying those counters that have reached zero, for example.

A determination is made as to whether at least one user requires new performance data (step 760). If not, the operation continues to step 810 where the operation is placed back into a sleep state. If at least one user requires new performance data, the performance data is obtained from one or more performance data sources (step 770). This may involve polling or interrogating performance monitor agents associated with the performance data sources for the new performance data, for example.

The obtained performance data is stored in a common data storage buffer/device (step 780) and pointers to the new performance data are added to the user data index table(s) of users requiring the new performance data (step 790). Thereafter, if a new user was registered in steps 720-730, the new user is lined up with at least one existing user based on the start times and refresh rate values (step 800). The operation then goes to sleep (step 810) until the next wake-up event. A determination may be made as to whether a termination event, e.g., a stopping of the performance monitoring tool or the polling system, has occurred (step 820) and if so, the operation will terminate. Otherwise the operation returns to step 720 and continues to monitor for new user registrations and wake-up events.

Thus, the present invention provides a mechanism for sharing polled data amongst a plurality of requesters, e.g., users or computing devices. In addition, the present invention provides a mechanism for reducing the size of the storage needed to maintain polled data for a plurality of users. Thus, the present invention improves upon known systems by reducing the number of transactions between a data polling system and data sources as well as reduces the amount of memory necessary to maintain polled data for a plurality of users, thereby reducing costs with regard to polling data sources for data that is to be shared with a plurality of users.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, of polling at least one data source for data to be shared with a plurality of requesting computing devices, comprising:
receiving, from a requesting computing device, a refresh rate for polling data sources;
aligning polling time points of the data sources for the requesting computing device with at least one other requesting computing device based on the refresh rate;
retrieving data from the at least one data source in accordance with the polling time points of the data sources; and
storing the data from the at least one data source in a storage location within a common data storage for the plurality of requesting computing devices.

2. The method of claim 1, further comprising:
generating an index data structure for the requesting computing device;
storing a pointer to the storage location in the index data structure for the requesting computing device; and
storing a pointer to the storage location in an index data structure for at least one other requesting computing device in the plurality of requesting computing devices.

3. The method of claim 1, wherein the data processing system performs the method in association with a performance monitoring tool, and wherein the data from the at least one data source is performance data for the data source.

4. The method of claim 1, wherein the refresh rate for polling data sources is a multiple of a predetermined minimum unit of refresh interval established by the data processing system.

5. The method of claim 2, further comprising:
initiating a counter in association with the index data structure, wherein an initial value of the counter is set to a value corresponding to the refresh rate for polling data sources.

6. The method of claim 5, further comprising:
periodically checking counter values for each of the plurality of requesting computing devices; and
decrementing a value of the counter associated with the index data structure in response to a check of the counter value, wherein retrieving data from the at least one data source and storing the data in a storage location within a common data storage for the plurality of requesting computing devices are performed in response to the value of the counter becoming a predetermined value.

7. The method of claim 5, further comprising:
setting the counter to a second value based on a function of the refresh rate and a counter value of the at least one other requesting computing device.

8. The method of claim 7, wherein the function is:
C₁=C₂ mod R₁
where C₁ is the second value for the counter of the requesting computing device, R₁ is the refresh rate for polling data sources, and C₂ is the counter value for the other requesting device.

9. The method of claim 5, wherein the second value of the counter is set equal to the refresh rate of the requesting computing device if a value for the counter is currently equal to zero.

10. A computer program product in a computer readable medium for polling at least one data source for data to be shared with a plurality of requesting computing devices, comprising:
first instructions for receiving, from a requesting computing device, a refresh rate for polling data sources;
second instructions for aligning polling time points of the data sources for the requesting computing device with at least one other requesting computing device based on the refresh rate;
third instructions for retrieving data from the at least one data source in accordance with the polling time points of the data sources; and
fourth instructions for storing the data from the at least one data source in a storage location within a common data storage for the plurality of requesting computing devices.

11. The computer program product of claim 10, further comprising:
fifth instructions for generating an index data structure for the requesting computing device;
sixth instructions for storing a pointer to the storage location in the index data structure for the requesting computing device; and
seventh instructions for storing a pointer to the storage location in an index data structure for at least one other requesting computing device in the plurality of requesting computing devices.

12. The computer program product of claim 10, wherein the data processing system executes the first, second, third and fourth instructions in association with a performance monitoring tool, and wherein the data from the at least one data source is performance data for the data source.

13. The computer program product of claim 10, wherein the refresh rate for polling data sources is a multiple of a predetermined minimum unit of refresh interval established by the data processing system.

14. The computer program product of claim 11, further comprising:
eighth instructions for initiating a counter in association with the index data structure, wherein an initial value of the counter is set to a value corresponding to the refresh rate for polling data sources.

15. The computer program product of claim 14, further comprising:
ninth instructions for periodically checking counter values for each of the plurality of requesting computing devices; and
tenth instructions for decrementing a value of the counter associated with the index data structure in response to a check of the counter value, wherein the third instructions for retrieving data from the at least one data source and fourth instructions for storing the data in a storage location within a common data storage for the plurality of requesting computing devices are executed in response to the value of the counter becoming a predetermined value.

16. The computer program product of claim 14, further comprising:
eleventh instructions for setting the counter to a second value based on a function of the refresh rate and a counter value of the at least one other requesting computing device.

17. The computer program product of claim 16, wherein the function is:
C₁=C₂ mod R₁
where C₁ is the second value for the counter of the requesting computing device, R₁ is the refresh rate for polling data sources, and C₂ is the counter value for the other requesting device.

18. The computer program product of claim 14, wherein the second value of the counter is set equal to the refresh rate of the requesting computing device if a value for the counter is currently equal to zero.

19. An apparatus for polling at least one data source for data to be shared with a plurality of requesting computing devices, comprising:
a processor;
a common data storage coupled to the processor; and
a network interface coupled to the processor, wherein the processor receives, from a requesting computing device via the network interface, a refresh rate for polling data sources, aligns polling time points of the data sources for the requesting computing device with at least one other requesting computing device based on the refresh rate, retrieves, via the network interface, data from the at least one data source in accordance with the polling time points of the data sources, and stores the data from the at least one data source in a storage location within the common data storage for the plurality of requesting computing devices.

20. The apparatus of claim 19, further comprising a memory coupled to the processor, wherein the processor generates an index data structure for the requesting computing device in the memory, stores a pointer to the storage location in the index data structure for the requesting computing device, and stores a pointer to the storage location in an index data structure in the memory for at least one other requesting computing device in the plurality of requesting computing devices.
